(19) United States
(12) Patent Application Publication
(10) Pub. No.: US 2024/0200974 A1
(43) Pub. Date: Jun. 20, 2024

(54) METHOD, APPARATUS, AND COMPUTER PROGRAM PRODUCT FOR ROAD SURFACE ANOMALY DETECTION

(71) Applicant: HERE GLOBAL B.V., Eindhoven (NL)

(72) Inventors: Jeremy Michael YOUNG, Chicago, IL (US); Jerome BEAUREPAIRE, Nantes (FR); Leon STENNETH, Chicago, IL (US)

(21) Appl. No.: 18/067,342

(22) Filed: Dec. 16, 2022

(51) Int. Cl. G01C 21/00; B60W 10/22; B60W 40/06; B60W 50/14; G06V 10/70; G06V 20/56

(52) U.S. Cl. CPC G01C 21/3822; B60W 10/22; B60W 40/06; B60W 50/14; G06V 10/70; G06V 20/588; B60W 2050/0083

(57) ABSTRACT

A method, apparatus, and computer program product are provided for using visual analysis of a road surface to identify markings indicative of road surface anomalies. Methods may include, for example: receiving data from an image sensor associated with a vehicle traveling along a road segment; identifying, within the data, a visual indication of a road surface anomaly, where the visual indication is a result of the road surface anomaly; and cause at least one of: an indication of the road surface anomaly to be provided to a user of the vehicle; a vehicle operational setting to be changed responsive to the road surface anomaly; or a map update to be generated to include the road surface anomaly within a map database.

### TECHNOLOGICAL FIELD

An example embodiment relates generally to detecting anomalies in a road surface, such as undulations, bumps, and potholes, and more particularly, to using visual analysis of a road surface to identify markings indicative of road surface anomalies.

### BACKGROUND

Vehicle technology is evolving at a rapid pace, with vehicle sensor arrays becoming increasingly capable of providing a vast amount of data relating to the environment and context of the vehicle. Vehicles capable of autonomous control are equipped with highly capable sensor arrays. Image sensors and Light Distancing and Ranging (LiDAR) are popular sensor types for identifying objects along a road segment and establishing the safe path of traversal for a vehicle driving autonomously.

Image sensors and LiDAR may further be used to more precisely locate a vehicle in an environment through image comparison with a database of established road segment features. Such vehicle locating may be beneficial in situations in which Global Positioning Systems (GPS) are unavailable or unreliable and may provide improved accuracy with respect to GPS locating. Further, the use of object and feature detection may provide accurate orientation of a vehicle in addition to location, and information pertaining to an environment of a vehicle, such as road conditions.

### BRIEF SUMMARY

Accordingly, a method, apparatus, and computer program product are provided for using visual analysis of a road surface to identify markings indicative of road surface anomalies. Embodiments may include an apparatus having at least one processor and at least one non-transitory memory including computer program code instructions, the computer program code instructions configured to, when executed, cause the apparatus to at least: receive data from an image sensor associated with a vehicle traveling along a road segment; identify, within the data, a visual indication of a road surface anomaly, where the visual indication is a result of the road surface anomaly; and cause at least one of: an indication of the road surface anomaly to be provided to a user of the vehicle; a vehicle operational setting to be changed responsive to the road surface anomaly; or a map update to be generated to include the road surface anomaly.

According to some embodiments, the visual indication of the road surface anomaly is not the road surface anomaly itself. The road surface anomaly of an example embodiment includes a non-flat road surface, and the visual indication includes marks on a road surface caused by vehicles traversing the road surface anomaly. According to some embodiments, the marks on the road surface caused by vehicles traversing the road surface anomaly are past the road surface anomaly in a direction of travel along the road segment.

According to certain embodiments, causing the apparatus to identify, within the data, the visual indication of the road surface anomaly includes causing the apparatus to: process data from the image sensor using a machine learning model, and identify, within the data from the image sensor, the visual indication of the road surface anomaly using the machine learning model. The apparatus of an example embodiment is further caused to receive motion sensor data from a motion sensor associated with the vehicle, and determine a severity of the road surface anomaly based, at least in part, on the motion sensor data. According to some embodiments, the indication to be provided to the user of the vehicle includes a recommended speed for the vehicle with which to traverse the road surface anomaly. According to certain embodiments, the vehicle operational setting to be changed responsive to the road surface anomaly includes a change to a firmness of a suspension of the vehicle.

Embodiments provided herein include a computer program product including at least one non-transitory computer-readable storage medium having computer-executable program code instructions stored therein, the computer-executable program code instructions including program code instructions to: receive data from an image sensor associated with a vehicle traveling along a road segment; identify, within the data, a visual indication of a road surface anomaly, where the visual indication is a result of the road surface anomaly; and cause at least one of: an indication of the road surface anomaly to be provided to a user of the vehicle; a vehicle operational setting to be changed responsive to the road surface anomaly; or a map update to be generated to include the road surface anomaly within a map database.

According to some embodiments, the visual indication of the road surface anomaly is not the road surface anomaly itself. According to certain embodiments, the road surface anomaly comprises a non-flat road surface, and the visual indication comprises marks on a road surface caused by vehicles traversing the road surface anomaly. According to certain embodiments, the marks on the road surface caused by vehicles traversing the road surface anomaly are past the road surface anomaly in a direction of travel along the road segment.

The program code instructions to identify, within the data, the visual indication of a road surface anomaly include program code instructions to process data from the image sensor using a machine learning model, and identify, within the data from the image sensor, the visual indication of the road surface anomaly using the machine learning model. The computer program product of some embodiments includes program code instructions to receive motion sensor data from a motion sensor associated with the vehicle, and determine a severity of the road surface anomaly based, at least in part, on the motion sensor data. According to some embodiments, the indication to be provided to the user of the vehicle comprises a recommended speed for the vehicle with which to traverse the road surface anomaly. According to certain embodiments, the vehicle operational setting to be changed responsive to the road surface anomaly comprises a change to a firmness of a suspension of the vehicle.

Embodiments provided herein include a method including: receiving data from an image sensor associated with a vehicle traveling along a road segment; identifying, within the data, a visual indication of a road surface anomaly, where the visual indication is a result of the road surface anomaly; and causing at least one of: an indication of the road surface anomaly to be provided to a user of the vehicle; a vehicle operational setting to be changed responsive to the road surface anomaly; or a map update to be generated to include the road surface anomaly within a map database.

According to some embodiments, the visual indication of the road surface anomaly is not the road surface anomaly itself. The road surface anomaly of an example embodiment includes a non-flat road surface, and the visual indication includes marks on a road surface caused by vehicles traversing the road surface anomaly. According to certain embodiments, the marks on the road surface caused by vehicles traversing the road surface anomaly are past the road surface anomaly in a direction of travel along the road segment.

Embodiments provided herein include an apparatus including: means for receiving data from an image sensor associated with a vehicle traveling along a road segment; means for identifying, within the data, a visual indication of a road surface anomaly, where the visual indication is a result of the road surface anomaly; and means for causing at least one of: an indication of the road surface anomaly to be provided to a user of the vehicle; a vehicle operational setting to be changed responsive to the road surface anomaly; or a map update to be generated to include the road surface anomaly within a map database.

According to some embodiments, the visual indication of the road surface anomaly is not the road surface anomaly itself. The road surface anomaly of an example embodiment includes a non-flat road surface, and the visual indication includes marks on a road surface caused by vehicles traversing the road surface anomaly. According to certain embodiments, the marks on the road surface caused by vehicles traversing the road surface anomaly are past the road surface anomaly in a direction of travel along the road segment.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of an apparatus according to an example embodiment of the present disclosure;

FIG. 2 is a block diagram of a system for identifying road surface anomalies from image data according to an example embodiment of the present disclosure;

FIG. 3 is a road segment including a road surface anomaly and a visual indication of the road surface anomaly according to an example embodiment of the present disclosure;

FIG. 4 is another road segment including a road surface anomaly and a visual indication of the road surface anomaly according to an example embodiment of the present disclosure;

FIG. 5 is still another road segment including a road surface anomaly and a visual indication of the road surface anomaly according to an example embodiment of the present disclosure;

FIG. 6 illustrates a vehicle and sensor arrangement according to an example embodiment of the present disclosure;

FIG. 7 illustrates another block diagram of a system for identifying road surface anomalies from image data according to an example embodiment of the present disclosure; and

FIG. 8 is a flowchart of a method for identifying road surface anomalies from image data according to an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are provided in accordance with an example embodiment of the present disclosure for using visual analysis of a road surface to identify markings indicative of road surface anomalies. The identification of road surface anomalies can be used for a variety of purposes. Road surface anomalies can be identified and mapped to specific locations, where those anomalies can be identified for road surface repair, warnings to other drivers, or for vehicles themselves to take any necessary precautions (e.g., slowing down, softening suspension, etc.). The identification of road anomalies is thus important for many purposes and practical applications.

Detecting and mapping road anomalies can also be beneficial for vehicles traveling among a road network for localization. A single road surface anomaly or a pattern of road surface anomalies may be used to more precisely locate a vehicle along a road segment, and possibly within a particular lane of a road segment.

Accurate locating of a vehicle within an environment facilitates navigation, route guidance, semi-autonomous, and fully autonomous vehicle control. Autonomous vehicles leverage sensor information relating to roads to determine safe regions of a road to drive and to evaluate their surroundings as they traverse a road segment. Further, autonomous and semi-autonomous vehicles use high-definition map information to facilitate autonomous driving and to plan autonomous driving routes. These high-definition maps or HD maps are specifically designed and configured to facilitate autonomous and semi-autonomous vehicle control. Including road anomalies within the HD maps can be beneficial for operation of autonomous vehicles and for localization as described herein.

HD maps have a high precision at resolutions that may be down to several centimeters that identify objects proximate a road segment, and features of a road segment including lane widths, lane markings, traffic direction, speed limits, lane restrictions, etc. Road anomalies can be added to the map as additional features. Autonomous and semi-autonomous vehicles use these HD maps to facilitate the autonomous control features, such as traveling within a lane of a road segment at a prescribed speed limit. Autonomous vehicles may also be equipped with a plurality of sensors to facilitate autonomous vehicle control, and to identify or confirm additional road anomalies. Sensors may include image sensors/cameras, Light Distancing and Ranging (LiDAR), Global Positioning Systems (GPS), Inertial Measurement Units (IMUs), or the like which may measure the surroundings of a vehicle and communicate information regarding the surroundings to a vehicle control module to process and adapt vehicle control accordingly. According to embodiments described herein, vehicles may be equipped with image sensors configured to identify visual features of a road and discern road anomalies therein. For example, minor changes in elevation from dips or bumps can be identified based on a visual analysis of visual indications observed on the road surface. For example, visual indications can include exhaust and/or oil tracks on the road surface. Road surface scratches can also be used to identify where vehicles scraped the surface of a roadway.

HD maps may be generated and updated based on sensor data from vehicles traveling along road segments of a road network. These vehicles may have various degrees of autonomy and may be equipped with a variety of different levels of sensors. Sensors from fully autonomous vehicles, for example, may be used to update map data or generate new map data in a form of crowd-sourced data from vehicles traveling along road segments. For example, image data from a vehicle can be received and processed through a machine learning model to identify oil tracks and exhaust tracks along a lane of a road segment, and such a machine learning model could identify from those tracks the presence and location of an undulation in the road surface. For example, this can be accomplished using supervised machine learning techniques based on ground truth data to build and/or update the model, and then such model can be used to predict undulations or other anomalies in other areas, for example, where there is not sufficient ground truth data.

According to some embodiments, vehicles may include multiple sensors and may seek to compare the data between the different sensors and/or sensor types to determine how closely they match. For example, geo-referenced image data may be correlated with geo-referenced accelerometer data to provide redundancy and evaluate accuracy of various sensors when redundant data is available. An undulation identified in a road segment that is being traversed by a vehicle should generate some degree of vertical acceleration of that vehicle as it traverses the undulation. Thus, such correlation can increase the confidence with which an actual road surface anomaly was detected and reported in map data.

Embodiments described herein may broadly relate to the collection of image data from sensors of a vehicle and to extract relevant images indicative of road surface anomalies for localization, map building, and vehicle control. Roads include many irregularities and unique sequences of irregularities or anomalies that make each road segment unique. The irregularities may vary by lane and even position within a lane, such as a pothole, a crack, bump (e.g., road upheave), or may be consistent within an entire road segment, such as a seam that reaches across all lanes of a road, or a seam along a road separating two different road surface materials or repairs.

Road surface anomaly identification and storage may include the creation of road surface anomaly features from images and geo-referencing them to a map. The geo-referenced road surface anomaly features may be stored, such as within an HD map, as a separate map layer for example.

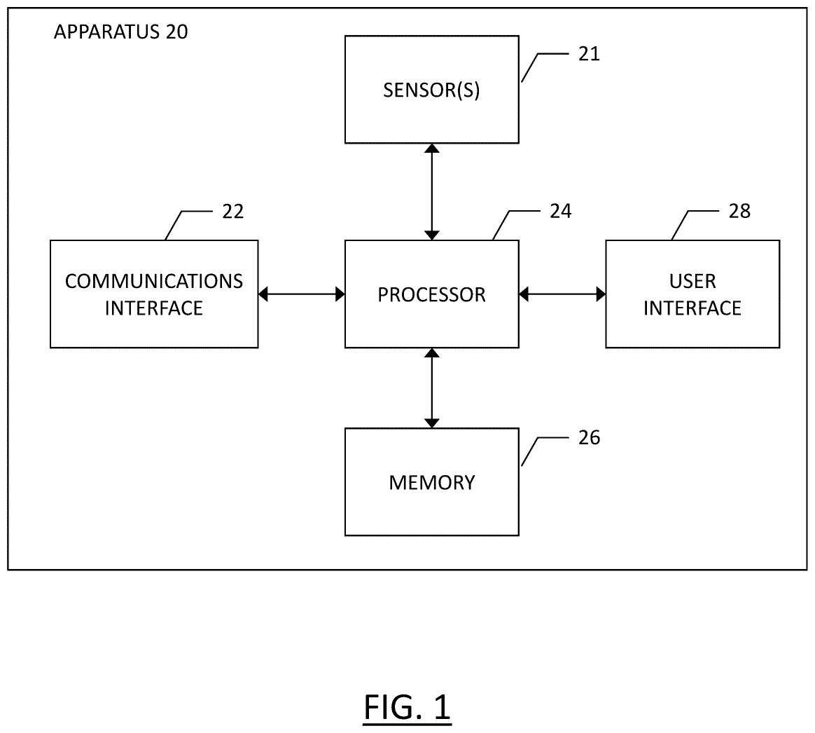

FIG. 1 is a schematic diagram of an example apparatus configured for performing any of the operations described herein. Apparatus 20 is an example embodiment that may be embodied by or associated with any of a variety of computing devices that include or are otherwise associated with a device configured for providing advanced driver assistance features which may include a navigation system user interface. For example, the computing device may be an Advanced Driver Assistance System module (ADAS) which may at least partially control autonomous or semi-autonomous features of a vehicle. However, as embodiments described herein may optionally be used for map generation, map updating, and map accuracy confirmation, embodiments of the apparatus may be embodied or partially embodied as a mobile terminal, such as a personal digital assistant (PDA), mobile telephone, smart phone, personal navigation device, smart watch, tablet computer, camera or any combination of the aforementioned and other types of voice and text communications systems. In a preferred embodiment where some level of vehicle autonomy is involved, the apparatus 20 is embodied or partially embodied by an electronic control unit of a vehicle that supports safety-critical systems such as the powertrain (engine, transmission, electric drive motors, etc.), steering (e.g., steering assist or steer-by-wire), and braking (e.g., brake assist or brake-by-wire). Optionally, the computing device may be a fixed computing device, such as a built-in vehicular navigation device, assisted driving device, or the like.

Optionally, the apparatus may be embodied by or associated with a plurality of computing devices that are in communication with or otherwise networked with one another such that the various functions performed by the apparatus may be divided between the plurality of computing devices that operate in collaboration with one another.

The apparatus 20 may be equipped or associated with any number of sensors 21, such as a global positioning system (GPS), accelerometer, LiDAR, radar, and/or gyroscope. Any of the sensors may be used to sense information regarding the movement, positioning, or orientation of the device for use in navigation assistance, as described herein according to example embodiments. The apparatus 20 may further be equipped with or in communication with one or more audio sensors or microphones. In some example embodiments, such sensors may be implemented in a vehicle or other remote apparatus, and the information detected may be transmitted to the apparatus 20, such as by near field communication (NFC) including, but not limited to, Bluetooth™ communication, or the like.

The apparatus 20 may include, be associated with, or may otherwise be in communication with a communications interface 22, processor 24, a memory 26 and a user interface 28. In some embodiments, the processor (and/or co-processors or any other processing circuitry assisting or otherwise associated with the processor) may be in communication with the memory via a bus for passing information among components of the apparatus. The memory may be non-transitory and may include, for example, one or more volatile and/or non-volatile memories. In other words, for example, the memory may be an electronic storage device (for example, a computer readable storage medium) comprising gates configured to store data (for example, bits) that may be retrievable by a machine (for example, a computing device such as the processor). The memory may be configured to store information, data, content, applications, instructions, or the like for enabling the apparatus to carry out various functions in accordance with an example embodiment of the present invention. For example, the memory could be configured to buffer input data for processing by the processor. Additionally or alternatively, the memory could be configured to store instructions for execution by the processor.

The processor 24 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 24 may be configured to execute instructions stored in the memory 26 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also include or otherwise be in communication with a user interface 28. The user interface may include a touch screen display, a speaker, physical buttons, and/or other input/output mechanisms. In an example embodiment, the processor 24 may comprise user interface circuitry configured to control at least some functions of one or more input/output mechanisms. The processor and/or user interface circuitry comprising the processor may be configured to control one or more functions of one or more input/output mechanisms through computer program instructions (for example, software and/or firmware) stored on a memory accessible to the processor (for example, memory 26, and/or the like). In this regard, the apparatus 20 may use road surface anomaly information to present information to a user via the user interface 28 such as a warning regarding a pothole or the like so the user can take any necessary actions (if they are driving the vehicle), or to advise the user of any upcoming movement of the vehicle due to road surface anomalies.

The apparatus 20 of an example embodiment may also optionally include a communications interface 22 that may be any means such as a device or circuitry embodied in either hardware or a combination of hardware and software that is configured to receive and/or transmit data from/to other electronic devices in communication with the apparatus, such as by NFC, described above. Additionally or alternatively, the communication interface 22 may be configured to communicate over Global System for Mobile Communications (GSM), such as but not limited to Long Term Evolution (LTE), 5G (fifth generation cellular technology), or the like. In this regard, the communication interface 22 may include, for example, an antenna (or multiple antennas) and supporting hardware and/or software for enabling communications with a wireless communication network. Additionally or alternatively, the communication interface 22 may include the circuitry for interacting with the antenna(s) to cause transmission of signals via the antenna(s) or to handle receipt of signals received via the antenna(s). In some environments, the communication interface 22 may alternatively or also support wired communication and/or may alternatively support vehicle to vehicle or vehicle to infrastructure wireless links.

The apparatus 20 may support a mapping or navigation application so as to present maps or otherwise provide navigation or driver assistance, such as in an example embodiment in which map data is created or updated using methods described herein. For example, the apparatus 20 may provide for display of a map and/or instructions for following a route within a network of roads via user interface 28. In order to support a mapping application, the computing device may include or otherwise be in communication with a geographic database, such as may be stored in memory 26. For example, the geographic database includes node data records, road segment or link data records, point of interest (POI) data records, and other data records. More, fewer or different data records can be provided. In one embodiment, the other data records include cartographic data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. Furthermore, other positioning technology may be used, such as electronic horizon sensors, radar, LiDAR, ultrasonic and/or infrared sensors.

In example embodiments, a navigation system user interface may be provided to provide driver assistance to a user traveling along a network of roadways where image data is collected from image sensors and road surface anomalies are identified based on the image data. Optionally, embodiments described herein may provide assistance for autonomous or semi-autonomous vehicle control based on the identified anomalies, either in real-time or based on previously identified anomalies. Autonomous vehicle control may include driverless vehicle capability where all vehicle functions are provided by software and hardware to safely drive the vehicle along a path identified by the vehicle. Semi-autonomous vehicle control may be any level of driver assistance from adaptive cruise control, to lane-keep assist, or the like. Establishing vehicle location and position along a road segment may provide information useful to navigation and autonomous or semi-autonomous vehicle control by establishing an accurate and highly specific position of the vehicle on a road segment and even within a lane of the road segment such that map features in the HD map associated with the specific position of the vehicle may be reliably used to aid in guidance and vehicle control.

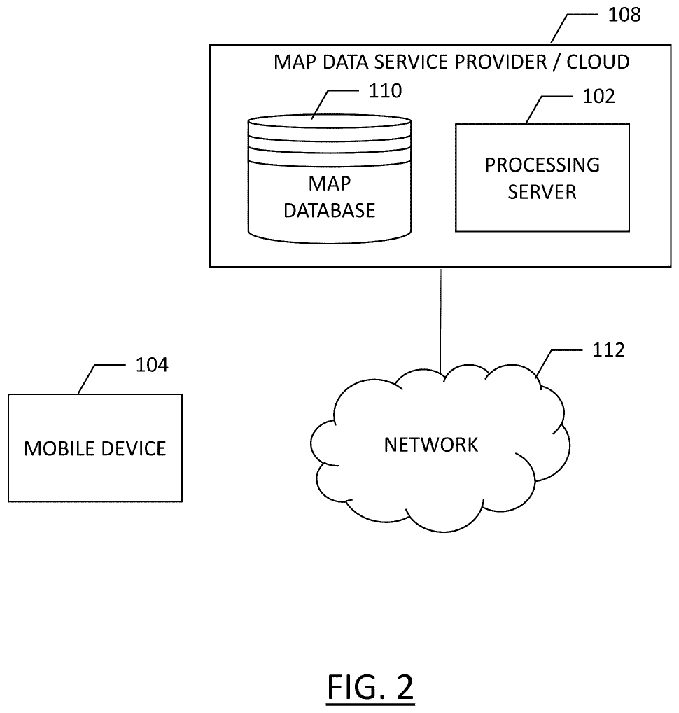

A map service provider database may be used to provide driver assistance via a navigation system and/or through an ADAS having autonomous or semi-autonomous vehicle control features. FIG. 2 illustrates a communication diagram of an example embodiment of a system for implementing example embodiments described herein. The illustrated embodiment of FIG. 2 includes a mobile device 104, which may be, for example, the apparatus 20 of FIG. 2, such as a mobile phone, an in-vehicle navigation system, an ADAS, or the like, and a map data service provider 108 or cloud service. Each of the mobile device 104 and map data service provider 108 may be in communication with at least one of the other elements illustrated in FIG. 2 via a network 112, which may be any form of wireless or partially wireless network as will be described further below. Additional, different, or fewer components may be provided. For example, many mobile devices 104 may connect with the network 112. The map data service provider 108 may provide cloud-based services and/or may operate via a hosting server that receives, processes, and provides data to other elements of the system.

The map data service provider 108 may include a map database 110 that may include node data, road segment data or link data, point of interest (POI) data, traffic data or the like. The map database 110 may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database 110 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 110 can include data about the POIs and their respective locations in the POI records. The map database 110 may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 110 can include event data (e.g., traffic incidents, construction activities, scheduled events, unscheduled events, etc.) associated with the POI data records or other records of the map database 110.

The map database 110 may be maintained by a content provider e.g., the map data service provider and may be accessed, for example, by the content or service provider processing server 102. By way of example, the map data service provider can collect geographic data and dynamic data to generate and enhance the map database 110 and dynamic data such as traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device 104, as they travel the roads throughout a region.

The map database 110 may be a master map database, such as an HD map database, stored in a format that facilitates updates, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device 104, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map data service provider 108 map database 110 may be a master geographic database, but in alternate embodiments, a client side map database may represent a compiled navigation database that may be used in or with end user devices (e.g., mobile device 104) to provide navigation and/or map-related functions. For example, the map database 110 may be used with the mobile device 104 to provide an end user with navigation features. In such a case, the map database 110 can be downloaded or stored on the end user device which can access the map database 110 through a wireless or wired connection, such as via a processing server 102 and/or the network 112, for example.

In one embodiment, as noted above, the end user device or mobile device 104 can be embodied by the apparatus 20 of FIG. 1 and can include an Advanced Driver Assistance System (ADAS) which may include an infotainment in-vehicle system or an in-vehicle navigation system, and/or devices such as a personal navigation device (PND), a portable navigation device, a cellular telephone, a smart phone, a personal digital assistant (PDA), a watch, a camera, a computer, and/or other device that can perform navigation-related functions, such as digital routing and map display. An end user can use the mobile device 104 for navigation and map functions such as guidance and map display, for example, and for determination of useful driver assistance information, according to some example embodiments.

Autonomous driving has become a focus of vehicle technology with advances in machine learning, computer vision, and computing power able to conduct real-time mapping and sensing of a vehicle's environment. Such an understanding of the environment is necessary for autonomous driving. Real-time or near real-time sensing of the environment may provide information about potential obstacles and road anomalies among other information. Further, map data including indications of road anomalies can be beneficial for vehicles to plan ahead of encountering an anomaly and possibly be used for localization of a vehicle.

Accurate localization of a vehicle is imperative for autonomous vehicle control. Such localization enables the understanding of a position and heading with respect to a roadway. On a coarse scale, navigation maps allow vehicles to know what roads to use to reach a particular destination. On a finer scale, maps allow vehicles to know what lanes to be in and when to make lane changes. This information is essential for planning an efficient and safe route as driving involves complex situations and maneuvers which need to be executed in a timely fashion, and often before they are visually obvious (e.g., a vehicle around a corner is stopped). Localization with respect to a map enables the incorporation of other real-time information into route planning. Such information can include traffic, areas with unsafe driving conditions (e.g., ice, weather, pot holes, etc.) and temporary road changes, such as may be caused by construction.

Autonomous vehicle navigation relies heavily on a locating system such as GPS which can provide a real-time location with a 95% confidence interval of 7.8 meters according to the standards set by governing agencies. However, in complex urban environments, reflection of GPS signals in “urban canyons” can increase the error such that location may be off by as much as 30 meters or more. Given that the width of many vehicle lanes is typically four meters or less, this accuracy is insufficient to properly localize an autonomous vehicle to enable safe route planning decisions. Other sensors, such as inertial measurement units (IMUs) can increase the accuracy of localization by taking into account vehicle movement, but these sensors may drift and fail to provide sufficient accuracy to ensure maximum safety.

Autonomous vehicle navigation requires localization accuracy, and accuracy to within 10 centimeters may provide sufficient accuracy for safety and effectiveness of autonomous navigation. One way to achieve this level of accuracy, as described herein, is through the use of geo-referenced road anomalies corresponding to road segments. The collection of road surface anomaly data can be matched to a database of geo-referenced road anomalies to establish a location and heading. The accuracy of anomalies encountered relative to anomalies within a map database may also be used to determine a degree to which a vehicle may rely on the accuracy of the stored map data. For instance, in an environment when localization is available from multiple sensors (e.g., GPS, visual odometry, wireless fingerprinting, geo-referenced audio, etc.), the data from the different sensors may be compared with one another and against the map database, such as the HD map, to confirm accuracy and to identify flaws in the map data.

In order to use road anomalies, such as undulations, bumps, dips, and potholes for localization and in real-time driving, identification of the anomalies is critical. According to example embodiments described herein, a vehicle using forward-facing sensors or a map maker using satellite imagery can detect points in the road where exhaust or oil tracks are present, and locations where they get wider or narrower in relation to the track ahead and behind such an oil spot. When an oil track gets wider in a direction of travel, this generally occurs when vehicles that have passed over this area have been closer to the road surface than in previous areas, which occurs when the suspension of a vehicle is compressed. Conversely, an oil or exhaust track gets narrower generally when a vehicle is higher above the road surface which occurs when suspension is extended. These two occurrences generally happen one after another when a bounce of a vehicle occurs as a result of a small but sudden (relative to vehicle speed) elevation shift in the road.

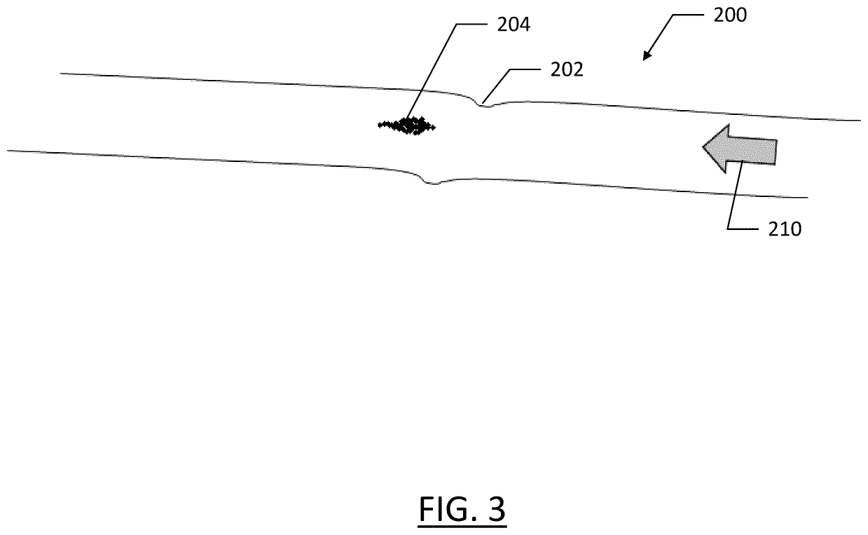

FIG. 3 illustrates an example embodiment of a road segment 200 including an anomaly 202 in the form of a dip in the road surface. An oil track 204 is present on the road surface after the anomaly 202 in the direction of travel of the road segment 200 indicated by arrow 210. The oil track 204 has a shape that is conventional to a dip in the road, where as a vehicle drops into the dip and the front wheels quickly encounter a rising road surface at the end of the dip, the front suspension compresses. This leads to a relatively sudden change in height of the powertrain of the vehicle relative to the road surface. This sudden change resulting in the powertrain of the vehicle being closer to the road surface results in a more pronounced oil track, particularly at the beginning of the oil track 204 due to the relatively sudden nature of the impact. As the vehicle suspension settles and raises the vehicle back to normal ride height, the oil track 204 narrows. The return to normal ride height is not as sudden as the initial impact from the dip in the road, such that the oil track is more pronounced at the beginning of the oil track, and tapers more gradually after the most dense part of the oil track—where the powertrain of the vehicle is likely to have been closest to the road surface.

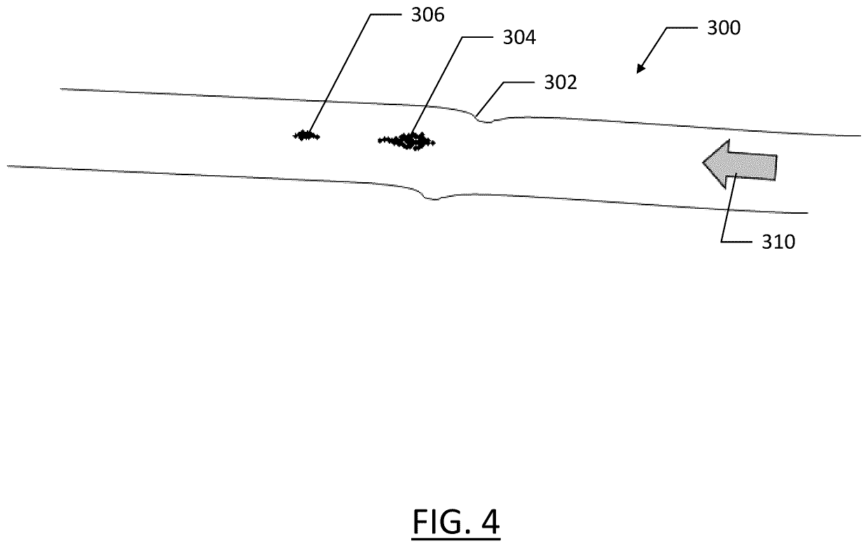

In some cases, the anomaly may be relatively severe, where the anomaly causes an initial bounce in the suspension, and is followed by a second cycle of compression of suspension of the vehicle as the springs of a vehicle oscillate in gradual decay in amplitude after a disturbance without sufficient dampening (e.g., from shock absorbers). FIG. 4 illustrates a road segment 300 with an anomaly 302 in the form of a dip in the road surface. An oil track 304 is formed past the dip in the direction of travel 310, and a second oil track 306 is also formed. This second, smaller oil track 306 is a result of vehicles bouncing after the anomaly 302. This can be caused by a larger anomaly, a faster speed along the road segment, and from vehicles with more compliant suspension and less damping.

Embodiments described herein include a process through which image analysis can be used to identify the road surface anomaly. Road surface anomalies may not be apparent from an image of the road surface material, as the generally uniform color and texture of a road surface can mask undulations, dips, potholes, and the like. However, oil tracks are often reliable indicators of the surface condition of a road segment.

The visual indication of a road surface anomaly in the form of an oil track or exhaust track can indicate an anomaly that may not be visually apparent. For example, within an aerial or satellite image, an oil track may be visible on a road surface. However, the undulation in the road surface that resulted in the visual indication is not visible. Thus, the visual indication of the road surface anomaly is not the road surface anomaly itself. The visual indication can include any visually distinction on a road surface, and is generally a mark or marks on a road surface indicative of a road surface anomaly. These marks can include scrapes, oil tracks, exhaust tracks, or other mark caused by a vehicle traversing a road surface anomaly. The road surface anomalies that cause such marks are generally any road surface change that upsets the travel of a vehicle along the road. These non-flat road surface anomalies can include undulations, pot holes, road heaves, cracks, or the like.

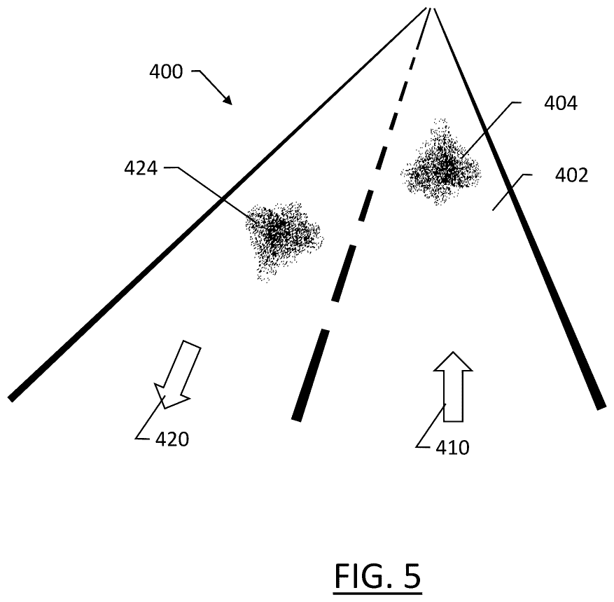

FIG. 5 illustrates an example embodiment of a road segment 400 with one lane in each direction. In a right lane, shown with direction-of-travel arrow 410, no road surface anomaly is visible, but one exists as a dip road surface anomaly 402. However, the oil track 404 is clearly visible from the perspective of a vehicle traveling along the right lane, such that an anomaly can be identified and anticipated. Further, in the case of an anomaly stretching across multiple lanes, oil track 424 is visible in the left lane indicated by direction-of-travel arrow 420. As the oil track 424 is from the opposite direction, it is found after the road surface anomaly 402 in that direction of travel.

Detection of indications of road surface anomalies such as oil tracks can be performed through image analysis. This image analysis can be performed in real-time as a vehicle is traveling along a road segment to inform the vehicle of upcoming road surface anomalies such that the vehicle and/or the driver can take any necessary precautions. These road surface anomalies can be provided to a map services provider for inclusion in map data, or for aggregation to determine if it is appropriate to add to map data. The image analysis can optionally be performed after image data is collected for a drive, such as by a map service provider, to identify road surface anomalies for adding to map data.

The image analysis is, in some embodiments, performed via machine learning model. For example, through artificial neural networks, convolutional neural networks, and deep learning. Image analysis such as the detection of indications of road anomalies is well suited for machine learning models due to the consistency with which the indicators are formed. As such, a machine learning model can process image data in real-time or process stored, aggregated data to identify indicators of road surface anomalies.

According to an example embodiment, in real-time, the vehicle traveling along the road segment where a road surface anomaly is detected can provide an indication to a user (e.g., via a user interface 28), such as a warning of a dip in the road, a bump (e.g., the crown of a crossing road), a pothole, or the like. The warning can include a recommended speed over the road surface anomaly, or a recommendation for a lane change, etc. The driver can take any necessary action, such as slowing down or avoiding the road surface anomaly. In the case of an autonomously controlled vehicle or semi-autonomously controlled vehicle, the vehicle itself can take any necessary precautions, such as slowing down or avoiding the road surface anomaly. Further, a vehicle with some degree of autonomous functionality can alter suspension settings based on an identified road surface anomaly. The suspension can stiffen or loosen depending upon a suspension setting prior to identification of the anomaly. The steering ratio can optionally be altered based on a detected road surface anomaly

Stiffening or loosening of a vehicle's suspension can be accomplished through adjustment to magnetorheological shock absorbers, dynamically adjustable spring rates, or through pneumatic or hydraulic means, for example. Adjusting suspension ahead of encountering an identified road surface anomaly can improve safety as the adjusted suspension can be adapted for better control responsive to an impact with the anomaly, and it can improve passenger comfort, such as by making a ride more compliant.

Road surface anomalies that are map-matched within map data, such as in map database 110 of map services provider 108, can be used in a similar manner as real-time detected road surface anomalies. A vehicle traveling along a road segment can be aware of an upcoming road surface anomaly based on the map data and take any necessary action accordingly. Similarly, a user interface can communicate the presence of an upcoming anomaly in the road surface for a driver to take any necessary action. This provides a predictive process through which road surface anomalies can be predicted by a vehicle based on the map data.

Embodiments described herein can employ acceleration data to confirm the presence of a road surface anomaly. For example, if map data indicates a road surface anomaly is present in a vehicle path, and the vehicle experiences an abrupt acceleration at that location, the road surface anomaly can be confirmed, or a confidence score relating to the road surface anomaly can be increased. Such a process can heal map data such as when a road surface anomaly is repaired. If a road surface anomaly is indicated in the map data, but either a visual indicator (e.g., oil track) is not present or an abrupt acceleration is not detected, a confidence score in that road surface anomaly may be decreased. Upon a road surface anomaly confidence level falling below a predetermined threshold (e.g., fewer than 50% of vehicles detect a road surface anomaly), the road surface anomaly may be eliminated from the map data.

Data collected by vehicles traveling along a road network can include location information, time information, and information pertaining to the detection of a road surface anomaly, such as image data depicting an oil track. This data can be aggregated by a map services provider to include a road surface anomaly in map data only after the anomaly has a sufficient confidence level. A single vehicle reporting a road surface anomaly may not be sufficient to establish the anomaly in the map data, but consistent reporting of a road surface anomaly at a specific location can be sufficient to raise the confidence level of the presence of the road surface anomaly.

The presence of road surface anomalies can be provided to municipalities or other entity responsible for road maintenance. The severity of the road surface anomaly can be identified through visual analysis (e.g., larger oil track) or through accelerometer data (e.g., from a wheel sensor, vehicle sensor, etc.). A greater severity may provide an indication to a road maintenance department that the anomaly requires attention.

Road surface anomalies in map data can optionally be used to provide route guidance to avoid such anomalies. An entire road may be avoided if feasible for a route if the road surface anomalies are sufficiently bad. Optionally, lane level guidance can be provided to a driver or an autonomous vehicle to avoid road surface anomalies. Certain vehicles may wish to avoid any road surface anomaly that is above a predetermined threshold of severity. Vehicles such as motorcycles may be more susceptible to road surface anomalies, such that routes for such vehicles can be generated to avoid road surface anomalies.

Road surface anomalies may be afforded a time to live (TTL), where a road surface anomaly may be removed from map data if no reports of the road surface anomaly have been received from vehicles traveling along a road segment for a predetermined amount of time (e.g., a week, a month, etc.).

Road surfaces may have other markings on them that resemble a road surface anomaly, when they may not actually be a road surface anomaly. For example, a spilled fluid on a road may not correspond to a road surface anomaly. An area of a road surface burned from an accident may appear to be a road surface anomaly, but may not actually be such an anomaly. False positives can be mitigated in a number of ways. For example, acceleration data from a vehicle or a plurality of vehicles traveling along a road segment may fail to correspond to a road surface anomaly, even when visual indications are present. Further, road accident data can be considered by a map service provider such that a road surface anomaly that is visually identified at a location where an accident recently occurred may provide a low confidence of an actual road surface anomaly existing. Such visual indicators of road surface anomalies can be identified and ignored as false positive detections.

According to example embodiments described herein, the role of HD maps in facilitating autonomous or semi-autonomous vehicle control includes crowd-sourced building of the maps to identify and confirm features of the maps. In the context of map-making, the features from the environment may be detected by a vehicle traveling along a road segment and consolidated to form a representation of the actual real-world environment in the form of a map, including road surface anomalies as described above. Embodiments described herein include a method, apparatus, and computer program product to use image data from image sensors to identify road surface anomalies along road segments.

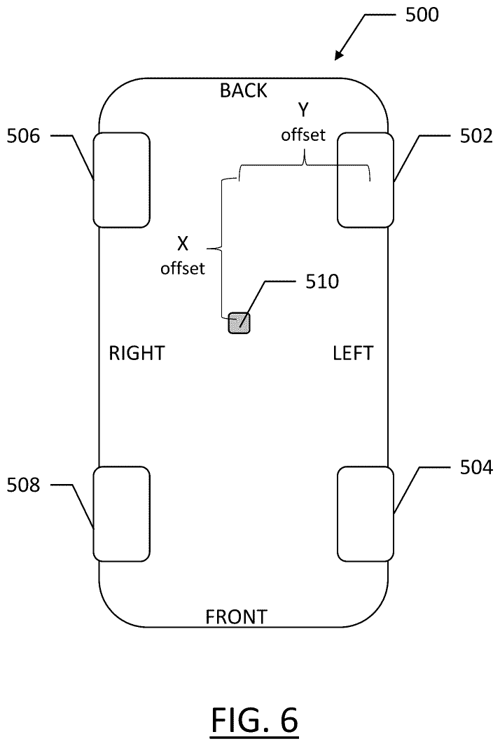

Upon identifying road surface anomalies within image data, those road surface anomalies and optionally the severity thereof can be confirmed through motion sensors associated with a vehicle, such as sensors 21 of apparatus 20 of FIG. 1. FIG. 6 illustrates an example embodiment of a sensor array implemented in a vehicle for collecting motion data of wheels of a vehicle to be processed together with image data to identify and confirm road surface anomalies. As shown, a vehicle 500 may include one or more motion sensors 502, 504, 506, and 508, such as accelerometers. While embodiments may be implemented with a single motion sensor, embodiments may include motion sensors at each wheel to capture movement related to each wheel as it contacts the roadway.

The locations of the wheels may each be identified in latitude and longitude based on a location of the vehicle using a sensor, such as a location sensor 510 (e.g., GPS sensor) to identify the location of the vehicle. Each vehicle or type of vehicle (e.g., make and model) may also be uniquely configured to identify an offset between the location sensor 510 and each of the wheels. As shown in FIG. 6, the location sensor 510 is located near a center of the vehicle, while the back or rear left wheel associated with sensor 502 is offset by an X offset and a Y offset. Thus, understanding a position of the vehicle through a position of location sensor 510 provides an identification of the location of the wheel using the offsets.

Using motion sensors configured to detect movement of each wheel, as illustrated in FIG. 6, motion sensor data may be collected for use in locating the vehicle along a road segment, and for locating surface anomalies within the road surface more precisely. The precise location of a wheel as it traverses a road surface anomaly can, during map building, more precisely locate an identified road surface anomaly. During localization, a known road surface anomaly with a known location can be used to more accurately locate a vehicle that encounters the road surface anomaly.

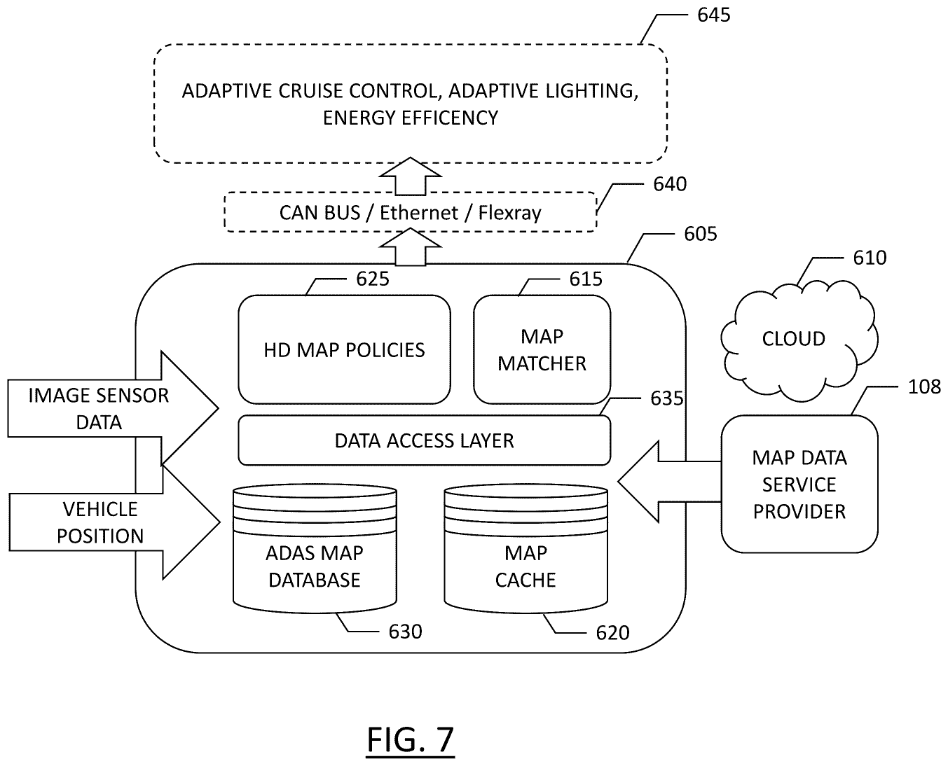

FIG. 7 illustrates an example embodiment of an architecture specifically configured for implementing embodiments described herein. The illustrated embodiment of FIG. 7 may be vehicle-based, where sensor data is obtained from sensors of a vehicle traveling along a road segment, such as the above-described image sensor data and motion sensor data. The location of the collected sensor data along the road segment may be determined through location determination using GPS or other localization techniques and correlated to map data of map data service provider 108. As illustrated, the architecture includes a map data service provider 108 that provides map data (e.g., HD maps and policies associated with road links within the map) to the Advanced Driver Assistance System (ADAS) 605, which may be vehicle-based or server based depending upon the application. The map data service provider may be a cloud-based 610 service. The ADAS receives navigation information and vehicle position and may use that information to map-match 615 the position to a road link on a map of the mapped network of roads stored in the map cache 620. This link or segment, along with the direction of travel, may be used to establish which HD map policies are applicable to the vehicle associated with the ADAS, including sensor capability information, autonomous functionality information, etc. Accordingly, policies for the vehicle are established based on the current location and the environmental conditions (e.g., traffic, time of day, weather). The HD map policies associated with the road segment specific to the vehicle are provided to the vehicle control, such as via the CAN (computer area network) BUS (or Ethernet or Flexray) 640 to the electronic control unit (ECU) 645 of the vehicle to implement HD map policies, such as various forms of autonomous or assisted driving, or navigation assistance.

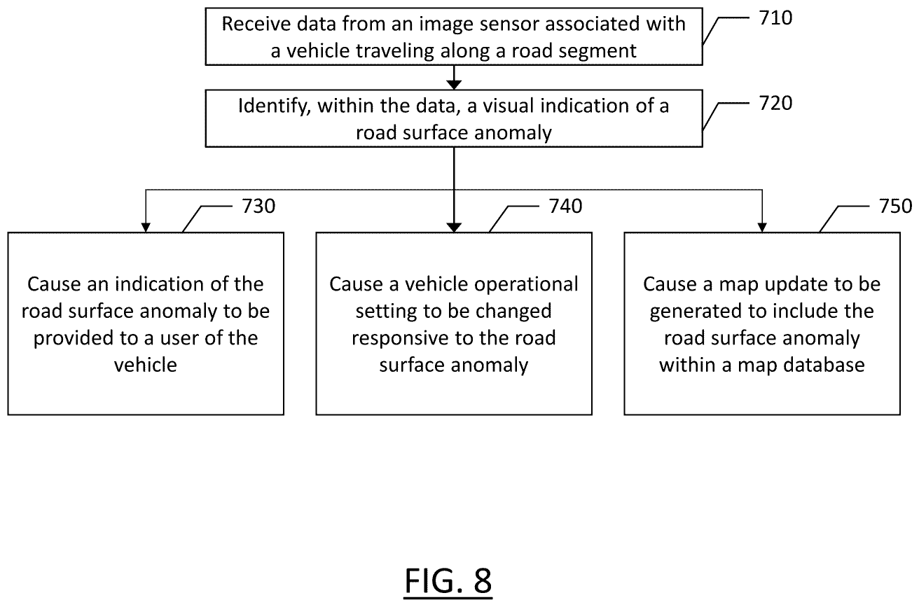

FIG. 8 illustrates a flowchart depicting a method according to an example embodiment of the present disclosure. It will be understood that each block of the flowchart and combination of blocks in the flowchart may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present invention and executed by a processor 24 of the apparatus 20. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

FIG. 8 is a flowchart of a method for detecting anomalies in a road surface, such as undulations, bumps, and potholes, and more particularly, to using visual analysis of a road surface to identify markings indicative of road surface anomalies. Data from an image sensor associated with a vehicle traveling along a road segment is received at 710. This image sensor may, in some cases, be a sensor of a vehicle having autonomous capabilities, where the image sensor detects features of the environment along which the vehicle is traveling. The images are processed to identify, within the data, a visual indication of a road surface anomaly at 720, where the visual indication is a result of the road surface anomaly. The visual indication of a road surface anomaly can include an area of a road surface that is distinct from the area around it or its context. Road surfaces are generally visually uniform. Anomalies, such as oil tracks, exhaust tracks, scrapes, potholes, etc. can be identified through image analysis based on their distinction from the road surface around them. According to one embodiment, an indication of the road surface anomaly is caused to be provided at 730 to a user of the vehicle. This indication may be provided, for example, via user interface, such as to communicate a warning or instruction to slow down or avoid the anomaly. This indication can include a perceived severity of an issue with the road surface that is visually indicated by the anomaly in the road surface. According to another embodiment, a vehicle operational setting is caused to be changed at 740 in response to the road surface anomaly. This setting may include, for example, a stiffness of the suspension of the vehicle, a responsiveness of a brake pedal, a steering ratio change, or the like. According to certain embodiments, a map update is caused to be generated at 750 to include the road surface anomaly within a map database. This map update can be used to warn other vehicles of the road surface anomaly and its location. This map update can optionally be used for localization given the accurate location of the road surface anomaly, whereby a vehicle can use the anomaly for localization when in the vicinity of the anomaly.

In an example embodiment, an apparatus for performing the method of FIG. 8 above may comprise a processor (e.g., the processor 24) configured to perform some or each of the operations (710-750) described above. The processor may, for example, be configured to perform the operations (710-750) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 710-750 may comprise, for example, the processor 24 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one non-transitory memory including computer program code instructions, the computer program code instructions configured to, when executed, cause the apparatus to at least:
receive data from an image sensor associated with a vehicle traveling along a road segment;
identify, within the data, a visual indication of a road surface anomaly, wherein the visual indication is a result of the road surface anomaly; and
cause at least one of:
an indication of the road surface anomaly to be provided to a user of the vehicle;
a vehicle operational setting to be changed responsive to the road surface anomaly; or
a map update to be generated to include at least one of the road surface anomaly or the visual indication of the road surface anomaly within a map database.

2. The apparatus of claim 1, wherein the visual indication of the road surface anomaly is not the road surface anomaly itself.

3. The apparatus of claim 1, wherein the road surface anomaly comprises a non-flat road surface, and wherein the visual indication comprises marks on a road surface caused by vehicles traversing the road surface anomaly.

4. The apparatus of claim 3, wherein the marks on the road surface caused by vehicles traversing the road surface anomaly are past the road surface anomaly in a direction of travel along the road segment.

5. The apparatus of claim 1, wherein causing the apparatus to identify, within the data, the visual indication of the road surface anomaly comprises causing the apparatus to:
process data from the image sensor using a machine learning model; and
identify, within the data from the image sensor, the visual indication of the road surface anomaly using the machine learning model.

6. The apparatus of claim 1, wherein the apparatus is further caused to:
receive motion sensor data from a motion sensor associated with the vehicle; and
determine a severity of the road surface anomaly based, at least in part, on the motion sensor data.

7. The apparatus of claim 1, wherein the indication to be provided to the user of the vehicle comprises a recommended speed for the vehicle with which to traverse the road surface anomaly.

8. The apparatus of claim 1, wherein the vehicle operational setting to be changed responsive to the road surface anomaly comprises a change to a firmness of a suspension of the vehicle.

9. A computer program product comprising at least one non-transitory computer-readable storage medium having computer-executable program code instructions stored therein, the computer-executable program code instructions comprising program code instructions to:
receive data from an image sensor associated with a vehicle traveling along a road segment;
identify, within the data, a visual indication of a road surface anomaly, wherein the visual indication is a result of the road surface anomaly; and
cause at least one of:
an indication of the road surface anomaly to be provided to a user of the vehicle;
a vehicle operational setting to be changed responsive to the road surface anomaly; or
a map update to be generated to include at least one of the road surface anomaly or the visual indication of the road surface anomaly within a map database.

10. The computer program product of claim 9, wherein the visual indication of the road surface anomaly is not the road surface anomaly itself.

11. The computer program product of claim 9, wherein the road surface anomaly comprises a non-flat road surface, and wherein the visual indication comprises marks on a road surface caused by vehicles traversing the road surface anomaly.

12. The computer program product of claim 11, wherein the marks on the road surface caused by vehicles traversing the road surface anomaly are past the road surface anomaly in a direction of travel along the road segment.

13. The computer program product of claim 9, wherein the program code instructions to identify, within the data, the visual indication of a road surface anomaly comprise program code instructions to:
process data from the image sensor using a machine learning model; and
identify, within the data from the image sensor, the visual indication of the road surface anomaly using the machine learning model.

14. The computer program product of claim 9, further comprising program code instructions to:
receive motion sensor data from a motion sensor associated with the vehicle; and
determine a severity of the road surface anomaly based, at least in part, on the motion sensor data.

15. The computer program product of claim 9, wherein the indication to be provided to the user of the vehicle comprises a recommended speed for the vehicle with which to traverse the road surface anomaly.

16. The computer program product of claim 9, wherein the vehicle operational setting to be changed responsive to the road surface anomaly comprises a change to a firmness of a suspension of the vehicle.

17. A method comprising:
receiving data from an image sensor associated with a vehicle traveling along a road segment;
identifying, within the data, a visual indication of a road surface anomaly, wherein the visual indication is a result of the road surface anomaly; and
causing at least one of:
an indication of the road surface anomaly to be provided to a user of the vehicle;
a vehicle operational setting to be changed responsive to the road surface anomaly; or
a map update to be generated to include at least one of the road surface anomaly or the visual indication of the road surface anomaly within a map database.

18. The method of claim 17, wherein the visual indication of the road surface anomaly is not the road surface anomaly itself.

19. The method of claim 17, wherein the road surface anomaly comprises a non-flat road surface, and wherein the visual indication comprises marks on a road surface caused by vehicles traversing the road surface anomaly.

20. The method of claim 19, wherein the marks on the road surface caused by vehicles traversing the road surface anomaly are past the road surface anomaly in a direction of travel along the road segment.
